(19) United States
(12) Patent Application Publication
(10) Pub. No.: US 2013/0309448 A1
(43) Pub. Date: Nov. 21, 2013

(54) COATING BASED ON POLYURETHANE FOR DISPLAY REGIONS

(71) Applicants: Harald Striegler, Ockenheim (DE); Bernadette Gerhartz-Quirin, Leverkusen (DE)

(72) Inventors: Harald Striegler, Ockenheim (DE); Bernadette Gerhartz-Quirin, Leverkusen (DE)

(73) Assignees: BAYER INTELLECTUAL PROPERTY GMBH, Monheim (DE); SCHOTT AG, Mainz (DE)

(21) Appl. No.: 13/822,194

(22) PCT Filed: Aug. 3, 2011
(86) PCT No.: PCT/EP2011/063349

§ 371 Date: Jul. 2, 2013

(30) Foreign Application Priority Data
Sep. 11, 2010 (DE) 10 2010 045 149.5

(51) Int. Cl. C03C 17/32; C08G 18/80

(52) U.S. Cl. CPC C03C 17/322; C08G 18/80
USPC 428/141; 428/423.1; 428/425.6; 428/323; 428/336; 428/425.8; 428/425.5; 428/413; 428/423.5; 428/423.3; 428/195.1; 428/210

(57) ABSTRACT

Transparent coating, the process for producing the coating and its use for display regions of shaped polymer, glass or glass-ceramic bodies, where the transparent coating is a baking polyurethane system.

The invention relates to a polyurethane coating having a low transmission in the wavelength range of visible light for display regions on shaped glass, glass-ceramic or polymer bodies, in particular for display regions of cooking surfaces or control panels of domestic appliances.

Coatings for display regions (“display layers”) based on organic binder systems have been known for a long time. In the case of cooking surfaces made of coloured glass-ceramic with knobs on the underside (e.g. CERAN HIGHTRANS®), they serve to even out the knobbed underside in the display region so that the lighting means (incandescent lamps, LEDs, etc.) shine clearly through the glass-ceramic. The displays serve, for example, for warning of a still hot cooking surface (known as residual heat displays).

The height of the knobs is usually 0.1-0.3 mm, their spacing is 1-5 mm and they are generally arranged in an offset manner. The knobs increase the mechanical stability (impact resistance and flexural strength) of the glass-ceramic plate and reduce contact with the ceramicization substrate (cf. WO 2003 086 019 A1).

DE 41 04 983 C1 describes, for example, sight windows made of knobbed plates. The valleys between the knobs of a glass plate or glass-ceramic plate are filled with a curing synthetic resin so as to give a smooth, even underside of the plate, which allows a largely clear view through the plate. As synthetic resins, mention is made of epoxy resins and silicone resins and also polyurethane resins. These synthetic resins can also be coloured in order to achieve particular optical effects. Corresponding to the knob height, the thickness of the synthetic resin layer is 0.01-1 mm.

DE 41 04 983 C1 does not mention any conditions for curing of the synthetic resins, so that a person skilled in the art would, for economic reasons, select self-curing synthetic resin systems (e.g. two-component systems which chemically crosslink at room temperature and also air- or moisture-crosslinking systems).

A further development of DE 41 04 983 C1 is mentioned in DE 44 24 847 B4. Here, a polymer mask with writing is placed on the same curable synthetic resin (inter alia polyurethane resins) and cured. This document, too, gives no information as to the conditions under which the resins crosslink or the criteria according to which the polyurethane resin should be selected, so that a person skilled in the art faced with choosing the polyurethane system would start out from a classical two-component system which crosslinks by polyaddition at room temperature. It would also be obvious to employ a one-component polyurethane coating composition which is based on moisture-curing polyisocyanates and likewise cures spontaneously in air at room temperature.

Owing to the additional heating step and the associated costs and the risk that the applied polymer mask could be deformed or melt, thermally curing coating systems are not obvious.

Knobbed glass-ceramic cooking surfaces generally have the disadvantage that the knobs in the display regions lead to distortions of the illuminated displays when the knobbed underside is not smoothed in an additional step (either by means of applied resins or by grinding). Knobs in the heating region can also interfere with the aesthetics when heat radiators (halogen or IR heating elements) are operated.

Glass-ceramic cooking surfaces which are smooth on both sides do not have the disadvantages mentioned. In the case of uncoloured glass-ceramic cooking surfaces which are smooth on both sides and are transparent to visible light and therefore bear an opaque coating on the underside, the display regions can even be uncoated and have, for example, an LCD display to show cooking recipes behind the glass-ceramic. Such a cooking surface is described in EP 1 837 314 B1.

However, the display regions can also be coated in such a way that the coating prevents a view into the interior of the hob but switched-on lighting devices arranged underneath the coating nevertheless shine through sufficiently brightly. This embodiment does not necessarily require large-area LCD displays in order to completely fill out the display region, but is also suitable for the more inexpensive 7-segment displays, displays of individual symbols, pictograms or writing. The advantage of coated display regions is that the cooking hob manufacturer gains design freedom in respect of the arrangement and combination of various lighting means.

Coatings which are suitable for such display regions of uncoloured, transparent glass-ceramic cooking surfaces which are smooth on both sides are described in DE 10 2006 027 739 B4. The noble metal coatings mentioned are notable, inter alia, in that they barely scatter visible light (the scattering is less than 1%) and, owing to their low transparency for visible light (the transmission for wavelengths of 400-750 nm is 1-21%), prevent a view through to the boards, cables and other components within the hob. The lighting devices which are arranged underneath the coated cooking surface in the display region therefore shine clearly through the coated glass-ceramic cooking surface during operation and in the non-operational state are hidden by the coating. Disadvantages of this high-quality coating are the high costs for the noble metals, the high baking temperatures required (about 800° C.) and the restricted choice of colours (only black, brown, silver, golden or copper-coloured layers can be obtained).

It is mentioned in the patent DE 10 2006 027 739 B4 that the known organic coatings (polyurethane, silicone, epoxy resin coatings), which can be coloured by means of organic pigments, pigment black, inorganic pigments or nanoparticles, are significantly inferior to the noble metal layers discovered in respect of mechanical, chemical and thermal stability. The patent gives no further information on the composition of the organic binders.

WO 2007 025 011 A1 proposes polyurethane coatings as scratch protection for mobile telephone displays and other display components. The polyurethane coatings can be uncoloured or tinted. No information is given as to how the colouring can be produced and for which purpose and how much the display coating should be tinted. The polyurethane system can, inter alia, be thermally cured and be either a two-component system or a one-component system. The two-component system can consist of a polyester polyol component and a diisocyanate component. The document gives no indication of which system is preferred. The one- and two-component systems are discussed equivalently and applied by spin coating, with a locally limited application or any structured coating not being possible.

WO 2003 098 115 A1, DE 10 2007 030 503 B4: FR 2 885 995 B1 and US 2007/0108184 A1 disclose sputtered coatings for display regions in cooking surfaces. These layers give display regions having a brightness comparable to noble metal layers, but are extremely expensive when producing small runs owing to the technology of gas-phase deposition and can only be structured by means of complicated masking technology.

Coating of display regions can also, similarly to the case of the layers described in DE 10 2006 027 739 B4, be effected by means of nanolayers of metal-organically bound titanium, zirconium, iron, etc. (known as lustre paints). Such coatings are known, for example, from WO 2008 047 034 A2. A disadvantage of these coatings is that they have to be baked at temperatures which are similarly high to those used for the noble metal coatings mentioned in order to achieve conversion of the metal-organic compounds into the corresponding oxides.

Apart from the abovementioned coatings for display regions, screen-printed coatings based on alkyl silicates (sol-gel systems) are also known from JP 2003 086 337 A2 and DE 10 2009 010 952 (not yet published for the first time). The substantial disadvantage of these systems is that the sol begins to crosslink during processing of the coating composition because of exposure to moisture, so that layers of comparable transparency from cooking surface to cooking surface can be obtained only when coating composition is continually supplied and the coating process is carried out continuously. In addition, the sol-gel coating compositions have a relatively low storage stability of only a few months and change in the event of temperature fluctuations during transport or storage. When the storage time is exceeded, or the storage or transport conditions are unfavourable, viscosity changes occur or the coating composition gels in the unopened container. The layers additionally contain effect pigments which scatter visible light considerably, so that numbers, letters or symbols displayed are blurred.

It is therefore an object of the invention to discover a coating system for display regions on smooth, transparent shaped bodies, which
is inexpensive,
is stable during storage and processing,
crosslinks at low temperatures (preferably below 200° C.),
can be structured easily and
gives a scratch-resistant, strongly adhering coating which
can be obtained in numerous colour shades,
is chemically resistant to water and oil,
is colour-stable on heating to up to 150° C.;
does not reduce the impact strength and flexural strength of the substrate to an unacceptable extent,
is sufficiently transparent for illuminated displays and
is sufficiently opaque to hide the non-operational displays and other components.

In particular cases, the coating system should also be suitable for capacitive touch switches or infrared touch switches and have a scattering of less than 6%.

The object is achieved by a coloured, organic surface coating composition based on blocked polyisocyanates.

Such baking polyurethane systems have the advantage that, even at very low crosslinking temperatures and very short crosslinking times which are possible neither in the case of the known sol-gel systems nor in the case of the known noble metal systems, they achieve sufficient scratch resistances and adhesive strengths for, with suitable pigmenting or colouring, layers which have low scattering and are a factor of 10-100 cheaper than the noble metal layers mentioned, are stable during storage and processing, and can also be applied as a structured coating in a simple manner by means of screen printing and also meet the other requirements demanded of coatings for display regions can be obtained.

The blocked polyisocyanate eliminates the blocking agent only at elevated temperature, so that the crosslinking reaction has to be started by thermal treatment. Relatively low temperatures of only 100-250° C., preferably 160-200° C., are sufficient to start the crosslinking reaction. Owing to the high transparency and low scattering capability of the pure polyurethane film, any desired number of colour shades and also the desired transmission can be obtained by suitable selection, combination and proportions of colorants. Dyes or finely divided pigments also make it possible to obtain layers having low scattering when the roughness of the uncoated substrate and also the roughness of the cured polyurethane film is in each case less than Rₐ=0.5 μm, in particular less than Rₐ=0.3 μm and preferably from Rₐ=0.001 μm to Rₐ=0.1 μm. The polyurethane system also has the required mechanical and chemical properties and can be made screen-printable so that structures such as linear bands, dots or the like can be produced with little engineering outlay. As a result, not only individually configured display regions but also decorative elements can be applied in a single process step.

Among the large number of available polyisocyanates, i.e. polyfunctional isocyanates having a plurality of free isocyanate groups, for example
aromatic polyisocyanates, e.g. tolylene 2,4-diisocyanate (TDI), diphenylmethane 4,4′-diisocyanate (MDI),
cycloaliphatic and araliphatic polyisocyanates, e.g. isophorone diisocyanate (IPDI), methylcyclohexyl 2,4-diisocyanate (HTDI), xylylene diisocyanate (XDI),
aliphatic polyisocyanates, e.g. hexamethylene diisocyanate (HDI) or trimethylhexamethylene diisocyanate (TMDI),
   preference is given to using aliphatic isocyanates because they form the most thermally stable polyurethanes. HDI in particular enables surface coatings having excellent thermal stability and yellowing resistance to be obtained. In general, not the monomeric isocyanates but oligomers or polymers of the monomers, e.g. their dimers, trimers or higher polymers, and also biurets, isocyanurates or adducts with trimethylolpropane or other polyhydric alcohols are used in the surface coatings because relatively nonvolatile components which are easier to handle are obtained as a result of the enlargement of the molecules.

Aliphatic isocyanates make it possible to produce urethanes which decompose only at 200-250° C. The thermal stability of polyurethane layers derived from aliphatic polyisocyanates is therefore even sufficient for use in display regions of cooking surfaces because temperatures of not more than 150° C. occur briefly in the display region of cooking surfaces on the underside in an unfavourable case, for example when a hot cooking pot gets onto the display region. However, this type of incorrect operation generally triggers an acoustic warning signal and the hob is switched off to protect the electronics located under the display region.

In order to obtain a processing- and storage-stable surface coating, blocked polyisocyanates (known as baking urethane resins, BU resins) have to be used. Suitable blocking agents are alcohols and phenols and also other Brönsted acids (proton donors, compounds having acidic hydrogen) such as thioalcohols, thiophenols, oximes, hydroxamic esters, amines, amides, imides, lactams or dicarbonyl compounds and in particular ε-caprolactam, butanone oxime, dimethylpyrazole, diisopropylamine and malonic esters such as diethyl malonate. While butanone oxime-blocked HDI makes it possible to formulate surface coatings which cure at 140-180° C. (5-60 minutes), ε-caprolactam-blocked HDI requires somewhat higher temperatures for crosslinking (160-240° C., 5-60 minutes). Surface coating resins which are crosslinked by means of diethyl malonate-blocked HDI cure at as low as 100-120° C. Since the blocking agent is liberated during crosslinking and diethyl malonate is not classified as a hazardous material and ε-caprolactam has a less critical classification as hazardous material compared to butanone oxime, preference is given to aliphatic polyisocyanates blocked by means of malonic esters or (despite the higher crosslinking temperature) ε-caprolactam. Butanone oxime, ε-caprolactam and most other blocking agents are given off from the surface coating film to a considerable extent during crosslinking and are removed from the surface coating composition with the exhaust air stream from the dryer. This shifts the reaction equilibrium from the side of the starting components to the side of the polyurethane.

Examples of suitable blocked polyisocyanates are, for example, the Desmodur® grades from Bayer MaterialScience Desmodur®BL 3175 SN and Desmodur® BL 3272 MPA. Table 1 gives an overview of the properties of these resins. The equivalent weight can be calculated from the content of blocked isocyanate groups. If the average NCO functionality of the blocked polyisocyanates is known, the average molecular weight can be determined therefrom. For the purposes of the present invention, the NCO functionality is the number of blocked and possibly free NCO groups per molecule.

The average molecular weight of preferred blocked polyisocyanates is 800-2000 g/mol. However, resins having molecular weights of 2000-10 000 g/mol can likewise be suitable.

In the case of suitable BU resins, the NCO functionality is ≧2, in particular 2.5-6, particularly preferably 2.8-4.2. However, resins having more than six blocked isocyanate groups per molecule are also suitable, if not preferred.

The blocked polyisocyanates are generally trimeric polyisocyanates, but dimeric, high oligomeric or polymeric blocked polyisocyanates are also suitable. Preference is given to polyisocyanates containing isocyanurate structures.

Table 1a: Properties of suitable BU resins

| | | NCO content, | Equivalent |
|---|---|---|---|
| Desmodur ® | Type | blocked | weight |
| BL 3175 SN | Butanone oxime-blocked, | about 11.1% | about 378 g/eq |
| | aliphatic polyisocyanate | | based on form |
| | based on HDI | | as supplied; |
| | (75% strength in solvent | | about 265 g/eq |
| | naphtha 100) | | based on solids |
| BL 3272 | Caprolactam-blocked, | about 10.2% | about 412 g/eq |
| MPA | aliphatic polyisocyanate | | based on form |
| | based on HDI | | as supplied; |
| | (72% strength in 1- | | about 296 g/eq |
| | methoxypropyl 2-acetate) | | based on solids |

Table 1b: Properties of suitable BU resins

| | | Density at | Average |
|---|---|---|---|
| | | 20° C. | molecular |
| | Viscosity at 23° C. | (DIN EN ISO | weight |
| Desmodur ® | 3219/A.3) | 2811-2) | (Mn) |
| BL 3175 SN | 3300 ± 400 mPa s | about 1.06 g/ml | about |
| | (75% strength in | | 1000 g/mol |
| | solvent naphtha 100) | | |
| BL 3272 | 2700 ± 750 mPa s | about 1.10 g/ml | about |
| MPA | (72% strength in | | 1100 g/mol |
| | 1-methoxypropyl 2- | | |
| | acetate) | | |

The average molecular weight can, for example, be determined by means of a GPC measurement (gel permeation chromatography).

As reaction partner for the blocked polyisocyanate, it is in principle possible to employ all compounds which contain a reactive (acidic) hydrogen atom. Polyols, in particular polyester polyols and polyether polyols, are highly suitable since mechanically and chemically very stable coatings can be obtained using these components. However, amines, polyamines, transesterification products of castor oil, linseed oil and soya bean oil with triols, alkyd resins, epoxy resins, silicone resins, phenolic resins or polyacrylate resins, vinyl polymers, cellulose esters such as ethylcelluloses can also serve as reaction partners.

The reaction of the blocked isocyanate groups or the free isocyanate groups after elimination of the blocking agent with compounds containing reactive hydrogen atoms forms the polyurethane by polyaddition. The properties of the polyurethane depend not only on the isocyanate components but also quite substantially on the H-acid compound selected. Naturally, it is also possible to combine various H-acid compounds, e.g. polyester polyols with silicone or epoxy resins, in particular, in order to match the film properties to specific requirements.

Polyester polyols, in particular branched polyester polyols, having a high hydroxyl group content (three and more hydroxyl groups per molecule, corresponding to an OH content of 2-8% by weight, in particular 3-6% by weight) and an average molecular weight in the range 1000-2000 g/mol have been found to be particularly suitable for coatings of display regions. This is because these polyols which lead to polyurethane films which are strongly crosslinked via their hydroxyl groups make it possible to produce particularly hard, scratch-resistant and chemically stable layers which are, surprisingly, nevertheless flexible enough not to split off even from glass-ceramic (a substrate having an extremely low thermal expansion). The more branched the polyester polyols and the more hydroxyl groups they have, the more strongly crosslinked is the polyurethane formed.

Examples of suitable polyester polyols are the Desmophen® grades from Bayer MaterialScience Desmophen® 651, Desmophen® 680 and Desmophen® 670. The only slightly branched Desmophen® 1800 having a low OH content, for example, is unsuitable because it gives only a weakly crosslinked polyurethane film which has a predominantly linear structure and is accordingly soft. Table 2 shows some characteristic properties of the resins.

Table 2a: Properties of various polyester polyols

| | Form | | | | Equivalent |
|---|---|---|---|---|---|
| | supplied | OH content | Molecular | Film | weight |
| Desmophen ® | (F. sup.) | (DIN 53240/2) | structure | hardness | (F. sup.) |
| 651 MPA | 65% | 5.5 ± 0.4% | branched | very hard | about |
| | strength in | | | | 310 g/eq |
| | MPA | | | | |
| 670 | 100% | 4.3 ± 0.4% | little | hard | about |
| | strength | | branching | | 395 g/eq |
| 680 BA | 70% | 2.2 ± 0.5% | branched | very hard | about |
| | strength in | | | | 770 g/eq |
| | BA | | | | |
| 1800 | 100% | 1.8 ± 0.1% | little | very soft | about |
| | strength | | branching | | 935 g/eq |

Table 2b: Properties of various polyester polyols

| | Viscosity at 23° C. | Density at 20° C. | Average |
|---|---|---|---|
| | (DIN EN ISO | (DIN EN ISO 2811- | molecular weight |
| Desmophen ® | 3219/A.3) | 2) | (Mn) |
| 651 MPA | 14 500 ± 3500 mPa s | about 1.11 g/ml | about 1620 g/mol |
| 670 | 2200 ± 400 mPa s | about 1.17 g/ml | about 1260 g/mol |
| | (80% strength in butyl | | |
| | acetate) | | |
| 680 BA | 3000 ± 500 mPa s | about 1.08 g/ml | about 1300 g/mol |
| 1800 | 21 500 ± 2500 mPa s | about 1.19 g/ml | about 2530 g/mol |

The molecular structure of most commercial polyester polyols, including the abovementioned Desmophen® grades, cannot be stated precisely since a polyol mixture is generally obtained in the production process. However, the properties of the polyester polyols can be set reproducibly by means of the reaction conditions, with the products being able to be characterized by the hydroxyl content (OH number), the average molecular weight, their density and the viscosity. The average OH functionality is determined by the choice of the starting components.

The monitoring and knowledge of the hydroxyl content (OH content) of the polyol component (H-acid component, also referred to as “binder”) and the knowledge of the content of blocked isocyanate groups (NCO content) of the polyisocyanate component, also referred to as “hardener”, are important because maximum crosslinking of the coating theoretically only occurs when stoichiometric amounts of hardener and binder are used, i.e. the stoichiometric ratio of hardener to binder is 1:1, according to the following reaction equation:

R—N═C═O+HO—R′→R—NH—CO—O—R′
Isocyanate Alcohol Urethane

The maximum crosslinking density which can be theoretically achieved at the stoichiometric ratio of 1:1 is critical to the properties of the coating (adhesion, scratch resistance, flexibility, chemical and thermal stability). Hardener and binder should therefore be present in the stoichiometric ratio 1:1 in the polyurethane system. The amounts necessary for this purpose can be calculated via the equivalent weight.

Reduction in the hardener content (under-crosslinking) leads to more flexible coatings having poorer mechanical and chemical stability and should therefore be avoided. An increase in the hardener content (over-crosslinking) increases the crosslinking density because the excess isocyanate groups react with atmospheric moisture to form urea groups. The use of hardener to binder equivalence ratios of from 1.1:1 to 2:1 can therefore be useful in order to increase the hardness of the coating and thus the scratch resistance or adhesion to the substrate. Since the secondary reaction with water is also made possible by other factors such as the water content of the solvent or the residual moisture content of the substrate, by means of which isocyanate groups are removed from the system and are therefore no longer available for reaction with the hydroxyl groups of the polyol component, equivalence ratios of hardener to binder in the order of from 1.1:1 to 2:1, in particular from 1.3:1 to 1.6:1, are preferred.

In order to obtain a surface coating which is transparent enough for illuminated displays and at the same time sufficiently opaque by means of the binder system described, which is colourless and transparent, the polyurethane system composed of blocked polyisocyanate and H-acid component (e.g. polyhydroxy resin) has to be coloured so that the transmission for visible light, τᵥᵢₛ, is in the range from 1 to 20%.

Colorants which are thermally stable in the long term at up to 100° C. and will briefly withstand temperatures of from 150° C. up to 250° C. are suitable. The colorants are not normally subjected to higher temperatures during crosslinking of the binder system and in later use.

Apart from the thermally very stable inorganic colorants, organic colorants are therefore also suitable. For the purposes of the present invention, colorants are all colour-imparting substances in accordance with DIN 55943. Because of the legal requirements for electric and electronic appliances, the colorants should not contain any lead, hexavalent chromium (Cr^{+VI}), cadmium or mercury. Inorganic coloured pigments and black pigments such as iron oxide pigments, chromium oxide pigments or oxidic mixed-phase pigments having a rutile or spinel structure and inorganic white pigments (oxides, carbonates, sulphides) are suitable. As examples of suitable pigments, mention may be made of iron oxide red pigments composed of haematite (α-Fe₂O₃), iron oxide black pigments having the approximate composition Fe₃O₄ and the mixed-phase pigments cobalt blue CoAlO₄, zinc iron brown (Zn,Fe)FeO₄, chromium iron brown (Fe,Cr)₂O₄, iron manganese black (Fe,Mn)(Fe,Mn)₂O₄, spinel black Cu(Cr,Fe)₂O₄ and also graphite and, as inorganic white pigments, TiO₂ and ZrO₂.

In order to achieve specific colouring effects, it is also possible to use inorganic lustre pigments (metal effect pigments, pearl effect pigments and interference pigments) or inorganic luminous pigments. Suitable metal effect pigments are, for example, platelet-like particles of aluminium, copper or copper-zinc alloys, suitable pearl effect pigments are, for example, bismuth oxychloride, suitable interference pigments are fire-coloured metal bronzes, titanium dioxide on mica, iron oxide on aluminium, on mica, on silicon dioxide or on aluminium oxide, suitable luminous pigments are fluorescent pigments such as silver-doped zinc sulphide or phosphorescent pigments such as copper-doped zinc sulphide.

As organic colorants, it is possible to use organic coloured pigments (e.g. monoazo pigments and diazo pigments such as naphthol AS, dipyrazolone), polycyclic pigments (e.g. quinacridone magenta, perylene red), organic black pigments (aniline black, perylene black), organic effect pigments (Fisch silver, liquid-crystalline pigments) or organic luminous pigments (azomethine fluorescent yellow, benzoxanthene fluorescent yellow) and also organic coloured and black dyes (e.g. cationic, anionic or nonionic dyes such as acridine, copper phthalocyanine, phenothiazine blue, disazo brown, quinoline yellow, cobalt, chromium or copper metal complex dyes of the azo, azomethine and phthalocyanine series, azo-chromium complex black, phenazine flexo black) and also organic luminous dyes (e.g. thioxanthene yellow, benzanthrone red, perylene green).

The average particle diameter of the pigments is usually in the range 1-25 μm (preferably 5-10 μm). D90 should be below 40 μm (preferably 6-15 μm), D50 should be below 25 μm (preferably 6-8 μm) and D10 should be below 12 μm (preferably 2-5 μm). Platelet-like pigments should have a maximum edge length of 60-100 μm (preferably 5-10 μm) so that the colour paste can be printed without problems at screen weaves of 140-31 (corresponding to a mesh opening of 36 μm) or 100-40 (corresponding to a mesh opening of 57 μm). In the case of coarser pigments, layers which scatter visible light to an excessive extent so that the illuminated display can no longer be discerned sufficiently clearly are obtained. The finer the pigments, the less does the coating in the display region (display layer) scatter visible light and the clearer (sharper) does the display become. At the particle sizes mentioned, the scattering is usually 5-40% (wavelength range: 400-750 nm) (see DE 10 2006 027 739 B4).

When using pigments having particle sizes below 1 μm, the scattering can be reduced to less than 6% (0.1-6%), in particular to 4-5%, as a result of which particularly clear displays become possible. The dispersion of nanoparticles normally requires a considerable additional outlay which is not always balanced by the gain in display quality. However, the outlay for pigmenting with carbon black remains within limits because of the special preparations available and gives coatings which barely scatter light and make possible particularly clear displays which extend to the display quality of noble metal coatings.

As mentioned, dyes, i.e. colorants which are soluble in the binder system, e.g. organic metal complex dyes such as the 1:2 chromium metal complex dyes Orasol® brown 2 GL, Orasol® black CN and Orasol® black RLI from BASF SE or inorganic compounds having colour-imparting ions, e.g. iron chloride, tungsten bronzes (NaₓWO₃), Berlin blue Fe₄[Fe(CN)₆]₃.H₂O, are also suitable if they colour sufficiently strongly and are thermally stable enough to withstand the stresses which occur during crosslinking of the polyurethane system and in later use. The colorants must not be strong oxidants since the binder system would be quickly decomposed by strong oxidants such as permanganates or dichromates under the action of light or heat. Dyes enable display layers having a surprisingly low scattering (0.01-1%) and roughness (Rₐ=0.001-0.02 μm, comparable to the uncoated substrate) to be obtained.

However, for a high display quality, in addition to the abovementioned low roughness and low scattering it is also important that the paint spreads uniformly, i.e. that a smooth film in which the pigments are uniformly distributed is formed and that the cured display coating does not contain any large, opaque particles, impurities or the like which can be seen with the naked eye (e.g. agglomerates, dust, fluff, particles having a size of more than 200 μm, in particular 0.3-1.5 mm). This is because such particles or pigment agglomerates lead, when they get into the beam of a lighting means, to dark spots having dimensions of 0.2-3 mm in the display, as a result of which the display quality is considerably decreased despite low scattering and roughness. Due to this requirement in the production of display layers having excellent display quality, it is necessary to pay attention to cleanliness in production. Production is ideally carried out under clean room conditions.

The pigment content which is necessary to achieve the desired transmission of 1-20% (for wavelengths in the range of visible light) in the coating depends greatly on the layer thickness of the coating and is, depending on the layer thickness, 0.1-45% by weight (based on the cured coating). The pigment content corresponds to a polyurethane content of 55-99.9% by weight. At greater layer thicknesses, lower pigment contents than in the case of small layer thicknesses are necessary.

The thickness of the polyurethane coating can be selected in the range 0.1-1000 μm, preferably 5-20 μm. At layer thicknesses below 0.1 μm, a sufficiently opaque coating can no longer be produced even at the maximum pigment content. Furthermore, the scratch resistance and adhesion would no longer be sufficient at a pigment content of more than 45% by weight. Layer thicknesses above 1000 μm are normally not customary because of the high materials consumption, which does not bring any further technical advantages. However, owing to the high transparency and flexibility of hard polyurethane systems, layer thicknesses in the millimetre range are also possible in particular cases.

As mentioned, carbon black is particularly suitable for producing coatings having low scattering. At a layer thickness of 8-12 μm, 2-5% by weight of carbon black, in particular 3.6±0.2% of carbon black (based on the cured coating) are necessary to obtain the desired transmission of 1-20% for visible light. Suitable carbon blacks are flame blacks (primary particle size 10-210 nm), furnace blacks (primary particle size 5-70 nm) and in particular the finely divided gas blacks (primary particle size 2-30 nm). The dispersibility can be improved when the carbon blacks are oxidatively after-treated, i.e. their surface is made highly hydrophilic by heating or treatment with strong oxidants.

Nevertheless, dispersing by means of a high-speed mixer normally does not suffice. If dispersion is insufficient, many small, black particles, i.e. carbon black agglomerates made up of agglomerated primary carbon black particles which have not been broken up, are visible to the naked eye in the coating. The carbon black agglomerates considerably impair the clarity of the display because they are conspicuous as black dots in the illuminated regions. Virtually all carbon black agglomerates can be broken up by subjecting the paint to relatively high shear forces, e.g. by means of three-roll mills, stirred ball mills or extruders (screw kneaders). However, these processes have the disadvantage that they are relatively complicated and that the carbon black concentration in the paint changes considerably because, for example, solvent evaporates during processing, carbon black is lost as dust or adheres to parts of the apparatus. However, a reproducibly constant carbon black concentration in the paint (±1% by weight, in particular ±0.2% by weight, based on the cured coating) is, in addition to a reproducibly constant layer thickness, the most important prerequisite for a reproducibly constant transmission of the coating.

It is therefore more advisable to use commercially available carbon black pastes. In these carbon black preparations, the carbon black has already been optimally dispersed in organic compounds, so that carbon black agglomerates no longer occur in the coating. The handling of the carbon black is considerably simpler because only the appropriate amount of the paste-like products now has to be weighed out. Commercially available carbon black preparations are, for example, the carbon black pastes Tack AC 15/200 (12% carbon black content), BB 40/25 (38-42% by weight carbon black content) from Degussa AG or the carbon black paste ADDIPAST 750 DINP (20-30% carbon black content) from Brockhues GmbH.

However, the carbon black preparations have the disadvantage that the organic component may possibly not be compatible with the favoured polyurethane system (composed of polyisocyanate and polyester polyol). In the case of the polyurethane system Desmodur®BL 3175 SN/Desmophen® 680 BA, specks occur when, for example, the carbon black paste Tack AC is used. A further disadvantage of the carbon black preparations is that the proportion of carbon black content can be subject to fluctuations from batch to batch as a result of the method of manufacture, with the abovementioned consequences for the transmission of the coating. A further disadvantage is that the carbon black preparations, e.g. the carbon black preparation Tack AC, can contain butyl acetate or other volatile solvents. However, volatile solvents in the paint should be avoided when coating is to be carried out by screen printing in order for the colour concentration to remain constant during processing (and not change due to evaporating solvent). This is because changes in the colour concentration during screen printing inevitably bring about changes in the viscosity, the layer thickness and thus ultimately also changes in the transmission of the cured coating. In the case of the other two carbon black preparations mentioned, a disadvantage is that plasticizers (benzyl butyl phthalate, BBP; diisononyl phthalate, DINP) are used as organic dispersion media and are hazardous to the environment and also human health.

The best possible way of dispersing the carbon black sufficiently finely and in a defined concentration in the polyurethane system without having to accept the abovementioned disadvantages of the carbon black pastes is to use specific granular materials in which the carbon black is dispersed in an organic matrix which is solid at 20° C. Such carbon black preparations are commercially available, for example under the name INXEL™ from Degussa AG or Surpass® from Sun Chemical Corporation. In these granular materials, the carbon black is melted in finely divided form into a polymer matrix. The polymer matrix can, possibly with addition of wetting agents, be dissolved in conventional solvents by dispersing by means of a high-speed mixer, so that a carbon black paste or a liquid carbon black dispersion which contains the free primary particles and is matched to the specific requirements of the respective application (solvent, concentration, viscosity) can be produced. As polymer matrix for the granular materials, use is normally made of aldehyde resins (e.g. Laropal® A 81 from BASF, a urea-aldehyde resin) which are very readily compatible with polyurethane systems and can be incorporated into the latter when they contain acidic hydrogen. The carbon black concentration in the granular materials varies according to the granular material and is in the range 20-60% by weight, in particular 25% by weight (INXEL™ Black A905) or 55% by weight (Surpass® black 647-GP47).

Suitable solvents for the pigmented polyurethane system in order to produce a screen printing ink are, in particular, aprotic, relatively nonvolatile solvents having an evaporation index EI of from 35 to >50 and a boiling point above 120° C., in particular above 200° C., e.g. butyl carbitol acetate (butyl diglycol acetate) which has an evaporation index (EI) of over 3000 (EI_{Diethyl ether}=1) and boils in the range 235-250° C.

Aprotic solvents of moderate volatility (EI=10-35) having a boiling point in the range 120-200° C., e.g. 1-methoxy-2-propyl acetate (EI=34), butyl acetate (EI=11) or xylene (EI=17) are also suitable. The high-boiling solvents of low or moderate volatility, which can also be used in combination with one another, firstly have the task of keeping the paint liquid, i.e. processable, in the screen. Secondly, it is important that the concentration of the colour remains constant during processing so that reproducible layer thicknesses and, as a result thereof, a constant transmission of the coating can be achieved. A constant concentration of the colour during processing can only be achieved with sufficient proportions of solvents of moderate or low volatility in the paint because solvents of high volatility (EI<10) evaporate during printing of the paint and the concentration of the paint would change to an unacceptable degree as a result.

However, experiments also show that solvents of high volatility (EI 1-10), e.g. methyl acetate (EI=2.2) or methylisobutyl ketone (EI=7), can be present in certain amounts (1-10% by weight based on the paint) without unacceptably high transmission changes occurring due to evaporation of the solvent and the associated increase in the concentration during the screen printing process. The proportion of solvents of high volatility must, in particular, not be any higher than the proportion of solvents of moderate and low volatility.

Aprotic solvents should be used because the isocyanate component of the binder system does not react with these solvents. If protic solvents such as n-butyl alcohol (EI=33), methoxypropanol (EI=38), butyl glycol (EI=165), butyl diglycol (EI>1200), phenoxypropanol or terpineols were to be selected, the isocyanate component would also react with the solvent during thermal curing, as a result of which the properties (chemical resistance, adhesion, etc.) of the coating would normally be changed in an unacceptable way. Reaction of an isocyanate component with n-butyl alcohol would, for example, lead to a polyurethane having little branching and poor scratch resistance. However, the reaction with the solvent can be desirable in particular cases. The reaction of the isocyanate component with a protic solvent can in particular cases also be prevented by using a protic solvent which is quickly given off from the printed film when the temperature is increased so that no protic solvent or a negligibly small amount of protic solvent is present in the film on reaching the deblocking temperature.

A screen printing ink pigmented with carbon black and based on the polyurethane system described should contain a total of 10-45% by weight of solvents, in particular 38-43% by weight of solvents. The viscosity of the paint (ink) is then in the range 500-3500 mPa·s, in particular 1000-3000 mPa·s, at a shear rate of 200 s⁻¹, so that the paint flows level without dripping and a uniform film is obtained.

When the polyurethane system is provided with pigments other than carbon black, the proportion of solvent can be significantly higher or lower, depending on the fineness of the pigments, the desired layer thickness and the coating method. The proportion of solvent should be determined by trials and be matched to the coating method.

If the pigmented polyurethane system is too liquid for use in screen printing and the proportion of solvent cannot be reduced further, the viscosity has to be increased by addition of rheological additives. Otherwise, the paint would drip through the fabric of the screen after flooding and processing would be impossible or be at least made very difficult.

Suitable rheological additives are thickeners and thixotropes which should ideally not change the colour shade, the transmission and the scattering of the cured coating.

Thickening can be achieved, for example, by addition of resins such as polyacrylates, polysiloxanes, thixotropicized acrylic resins and isocyanate- or urethane-thixotropicized alkyd resins which are solid or viscous at 20° C. Waxes such as hydrogenated castor oil or polyolefin waxes are also suitable. The nonnewtonian viscosity desired for screen printing inks can also be achieved using associative thickeners such as associative acrylate thickeners, hydrophobically modified cellulose ethers, hydrophobically modified ether urethanes (“polyurethane thickeners”), hydrophobically modified polyethers or modified ureas.

In the case of the organic or organically modified thickeners mentioned, the compatibility with the system and the tendency for yellowing to occur under thermal stress must in all events be evaluated. Thus, cellulose ethers in particular concentration ranges can also have the converse effect and reduce the viscosity further. Hydrogenated castor oil can, owing to its comparatively low thermal stability in the thermal crosslinking of the polyurethane system, lead to an undesirable brown colour caused by decomposition products. The problem of yellowing or brown colouration of the polyurethane system during thermal crosslinking does not occur in the case of purely inorganic thickeners since these normally have a higher thermal stability.

Suitable inorganic or organically modified inorganic thickeners are, for example, amorphous silicas or, in the case of polar solvents such as methoxypropyl acetate or butyl carbitol acetate, in particular hydrophilic, pyrogenic silicas.

However, organically modified, hydrophobic silicas or organo sheet silicates (organically modified bentonites, smectites, attapulgites) and also metal soaps, e.g. zinc or aluminium stearates and octoates, are also suitable for increasing the viscosity.

A disadvantage of the inorganic thickeners is that they can increase the scattering of the coating and thus reduce the transparency of the coating. However, the scattering of the coating surprisingly does not increase particularly greatly as a result of the addition of pyrogenic silicas, even at relatively high proportions (10-15% by weight in the crosslinked coating). The proportion of inorganic thickeners (based on the crosslinked layer) should be in the range 0.1-25% by weight, in particular in the range 3-15% by weight. At a proportion greater than 25% by weight of thickeners, other properties of the layer (thermal and mechanical stability) can also be significantly impaired. (The proportion in % by weight is based on the cured coating).

To optimize the printed image, in particular the formation of craters and Benard cells, and ensure good wetting and formation of a smooth, uniform film, antifoams, wetting agents or levelling agents should be added to the printing ink (e.g. 0.1-2% by weight of polysiloxane having a viscosity of 5000-50 000 mPa·s). This is because the formation of a uniform, smooth film is of critical importance to the quality of the display because the light from uneven layers having irregularly distributed pigment particles is deflected and the lighting means would not be clearly discernible despite very fine pigments.

The finished polyurethane paint can be pressure-filtered in order to remove fluff, dust or other particles introduced from the raw materials or in the production process, possibly also isolated (carbon black) agglomerates still present.

Coating of display regions of transparent materials, e.g. polymer, glass or glass-ceramic plates, in particular display regions in cooking surfaces or control panels, can be effected by spraying, dipping, casting, painting, screen printing, pad printing or other stamping processes. The coating can be applied in one or more layers, for example in order to produce colour differences, colour gradations or other colour effects and also transmission differences. Components which are in use not subjected to temperatures above 150° C. (e.g. control panels, automobile windscreens or fittings) can also be coated over the full area. In the case of a multilayer structure composed of identically or differently coloured polyurethane surface coatings of the composition described, individual regions can remain uncoated, by means of which differently coloured regions or regions having different transparency, including opaque regions having a transmission of less than 1%, can be produced.

Components which in use are not subjected to temperatures above 150° C. and only moderate mechanical stresses (e.g. fittings of automobiles, control panels of refrigerators, washing machines or dishwashers) can also be coated on the side facing the user. This is because coatings having high scratch resistance can be produced by means of the polyurethane system described.

The screen printing process offers the advantage that the thickness of the display coating can be defined precisely via the screen thickness, so that constant layer thicknesses can be produced with high accuracy even over wide-area regions in the manufacturing process. This aspect is, as mentioned above in the context of display layers, of particular importance because the transmission for the light of the lighting elements can be set in a defined way thereby and remains constant over the entire display region.

Suitable mesh thicknesses are 54-64, 100-40 and 140-31. In the case of applications which require a high edge sharpness, it is possible to use fine meshes (e.g. meshes 100-40 having a mesh opening of 57 μm or meshes 140-31 having a mesh opening of 36 μm). Layer thicknesses in the range 1-10 μm are normally obtained by means of these meshes. Relatively coarse mesh, e.g. mesh 54-64 (having a mesh opening of 115 μm), has the advantage that even relatively large pigment particles (e.g. effect pigments, platelet-like pearl effect pigments having edge lengths of up to 100 μm, etc.) can be used without the mesh openings of the screen being blocked during printing. If electrically conductive pigments (e.g. carbon black in the amount mentioned above) are used, sufficiently thick and thus sufficiently opaque display layers which, owing to the excellent insulating properties of the polyurethane binder system, are electrically nonconductive so that capacitive touch switches can be used underneath the display coating can be obtained using mesh 54-64 (or coarser mesh). In the case of finer mesh thicknesses which give thinner layers, higher pigment contents would be necessary in order to obtain a sufficiently opaque coating, as a result of which the conductivity of the coating can become unacceptably high for use of capacitive touch switches.

Furthermore, in the case of the screen printing process, a complicated masking technology (as in the case of spray processes or gas-phase deposition processes) is unnecessary for targeted application of the paint in uncoated regions of a plate which is smooth on both sides and coated so as to be opaque in the other regions. Even when the (opaque) coating of the region around the display region is very thick (up to 60 μm), so that the display layer has to be printed into a depression, no problems occur in the coating of the recessed display region despite the step to be overcome.

In particular, when the display layer is printed with an overlap of about 1-5 mm onto the coating in the remaining region, no unwetted places occur at the margins, i.e. at the edges where the coating of the surrounding region ends.

The overlapping printing of the display layer onto the coating of the surrounding region is advantageous. This is because owing to manufacturing tolerances, the accuracy with which the template for printing the display layer is oriented relative to all other previously printed layers (including upper side decor) is usually 0.3-1.0 mm. Without overlap with the surrounding underside coating, regions of the display window could remain uncoated due to offsetting of the template because of the manufacturing tolerances. However, when a sufficiently great overlap of the display layer with the surrounding coating is provided, it can be ensured that the entire display region is always completely filled by the display layer.

An important prerequisite in this context is that the display layer adheres sufficiently to the surrounding coating. In the case of display layers based on the polyurethane system described, it has been found that a good bond is achieved using alkyl silicate layers, in particular the systems mentioned in DE 103 55 160 B4 and DE 10 2005 018 246 A1, using noble metal coatings, in particular the systems described in DE 10 2005 046 570 B4 and DE 10 2008 020 895 B4, using sputtered systems (DE 10 2007 030 503 B4), using porous coatings based on glass (EP 1 435 759 A2) or crosslinked silicone coatings (DE 10 2008 058 318 B3). On the other hand, wetting and adhesion problems occur when the surrounding layer contains predominantly (more than 50% by weight based on the cured layer) uncrosslinked silicones (polysiloxanes) as film formers or is strongly hydrophobic. In this case, however, the polyurethane system can be modified appropriately by addition of silicone resins (e.g. methyl or phenyl silicone resins) or other resins.

The thermal curing of the applied polyurethane system is effected by heating to 100° C.-250° C., in particular by heating to 160-200° C., for a time of 1-60 minutes, in particular 30-45 minutes. As a result of heating, the solvent firstly evaporates from the paint and secondly the isocyanate component is deblocked so that the crosslinking reaction with the H-acid component (e.g. polyester polyol) proceeds and forms a solid film. Temperatures above 200° C. are normally not employed because the polyurethane formed begins to decompose at and above 200° C. The decomposition brings about a slight brown colouration of the coating which is generally undesirable. However, in particular cases, crosslinking can be carried out at a temperature higher than 250° C. for an extremely short time (1-5 minutes). The brief thermal stress then keeps the brown colouration within bounds.

The reaction temperature required depends, inter alia, quite substantially on the blocking agent by means of which the isocyanate component is blocked. Thus, in the case of isocyanates blocked with butanone oxime, 140-180° C. is sufficient to start crosslinking, while in the case of isocyanates blocked by means of ε-caprolactam, 160-240° C. is necessary. The time required for sufficient crosslinking depends on the choice of isocyanate component and H-acid compound (polyester polyol). It can be significantly shortened (to a few minutes) by means of catalysts, e.g. by means of tertiary amines but in particular by means of metal-containing catalysts, e.g. Zn, Co, Fe, Sn(IV), Sb and Sn(II) salts. Particularly suitable catalysts are tin(IV) alkoxylates such as dibutyl tin dilaurate and tetra(2-ethylhexyl)titanate, zinc naphthenate or cobalt naphthenate. The catalysts or the catalyst mixture are added in an amount of 0.05-1% by weight (based on the colour paste).

Owing to the low crosslinking temperature of the polyurethane system, not only transparent glass-ceramics but also transparent glasses (e.g. borosilicate glass, soda-lime glass, aluminosilicate glass, alkaline earth metal silicate glass), which can be rolled or floated and thermally or chemically prestressed (as described, for example, in EP 1 414 762 B1), or transparent plastics can be used as substrates.

The uncoated substrates can also be slightly tinted (e.g. brown, red or even blue), but must remain sufficiently transparent for illuminated displays (1%≦τᵥᵢₛ≦100%), they must not be opaque to light.

The substrates do not necessarily have to be flat plates but can also be angled or curved or shaped in another way.

For cooking surfaces, preference is given to using glass-ceramics of the Li₂O—Al₂O—SiO₂ type, in particular transparent, uncoloured glass-ceramics which have a thermal expansion of from −10·10⁻⁷ K⁻¹ to +30·10⁻⁷ K⁻¹ in the temperature range 30-500° C. and whose known composition is indicated, inter alia, in Table 3 below:

TABLE 3
Composition of suitable glass-ceramic substrates

| Element | | | |
|---|---|---|---|
| oxide | Glass-ceramic composition [% by weight] | | |
| SiO₂ | 66-70 | 50-80 | 55-69 |
| Al₂O₃ | >19.8-23 | 12-30 | 19-25 |
| Li₂O | 3-4 | 1-6 | 3-4.5 |
| MgO | 0-1.5 | 0-5 | 0-2.0 |
| ZnO | 1-2.2 | 0-5 | 0-2.5 |
| BaO | 0-2.5 | 0-8 | 0-2.5 |
| Na₂O | 0-1 | 0-5 | 0-1.5 |
| K₂O | 0-0.6 | 0-5 | 0-1.5 |
| TiO₂ | 2-3 | 0-8 | 1-3 |
| ZrO₂ | 0.5-2 | 0-7 | 1-2.5 |
| P₂O₅ | 0-1 | 0-7 | — |
| Sb₂O₃ | — | 0-4 | — |
| As₂O₃ | — | 0-2 | — |
| CaO | 0-0.5 | 0 | 0-1.5 |
| SrO | 0-1 | 0 | 0-1.5 |
| Nd₂O₃ | — | — | 0.004-0.4 |
| B₂O₃ | — | — | 0-1 |
| SnO₂ | — | — | 0-0.4 |
| Source | EP 1 170 264 B1 | JP 2004-193050 A2 | EP 1 837 314 B1 |
| | Claims 14-18 | | |

The glass-ceramics contain at least one of the following refining agents: As₂O₃, Sb₂O₃, SnO₂, CeO₂, sulphate or chloride compounds.

In a first example, a colourless glass-ceramic plate (1) which is smooth on both sides and has a width of about 60 cm, a length of 80 cm and a thickness of 4 mm and has the composition according to EP 1 837 314 B1 (Tab.3) and has been coated on the upper side with a ceramic decor paint (6) as described in DE 197 21 737 C1 in a grid of points which has been cut out in the display region (3) and ceramicized is used as starting substrate.

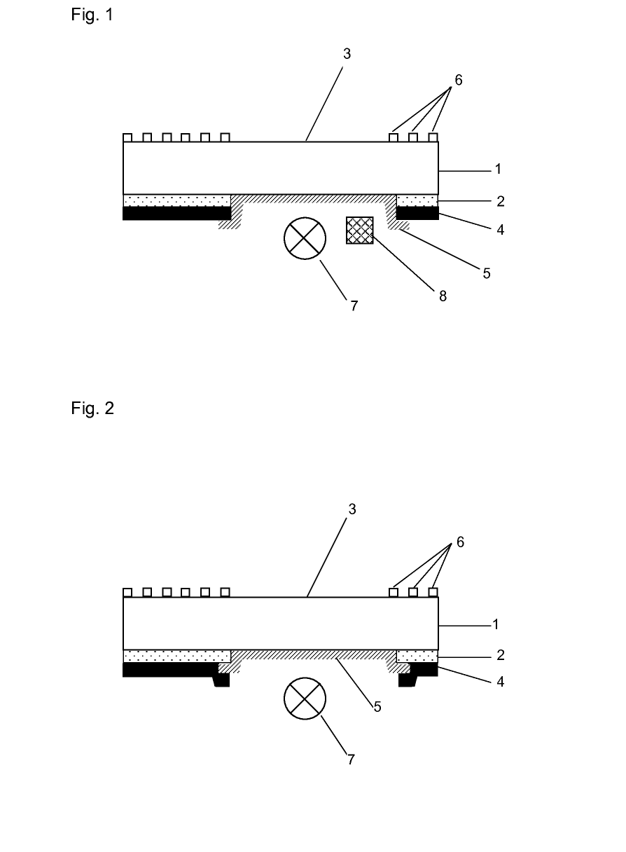

As shown in FIG. 1, a first, colour-imparting and opaque paint layer (2) composed of a sol-gel paint was subsequently applied by screen printing over the entire area of the underside of the ceramicized glass-ceramic plate (1), but without cutting-out of the display region.

The colour-imparting coating (2) was dried at 100° C. for 1 hour and baked at 350° C. for 8 hours. A further sol-gel paint (4) was subsequently printed as second paint layer (top coat) onto the first paint layer (2) and dried at 150° C. for 30 minutes in order to achieve properties such as a high scratch resistance and impermeability to water and oil. Details regarding the underside coating of glass-ceramic cooking surfaces with colour-imparting, opaque sol-gel layers may be found in DE 103 55 160 B4.

The polyurethane paint having the composition (A), Table 4, was then applied by screen printing (screen mesh 54-64) in the cut-out display region (3), with the display layer (5) obtained overlapping the surrounding coating by about 1 mm. instead of the paint having the composition (A), it is also possible to apply the other illustrative compositions (B) to (I). The compositions (A) to (D) differ only in the choice of the polyurethane component. In the case of the compositions (E) and (F), the stoichiometric ratio of hardener to binder was varied. It is 1.3:1 in the case of the composition (E) and is 1.6:1 in the case of the composition (F). The composition (G) contains coarser pigments as are used at present in display layers of cooking surfaces on the market instead of finely divided carbon black. The compositions (H) and (I) do not contain any pigment but instead a high-quality, organic metal complex dye which was dissolved in the polyurethane system. The polyurethane paints were crosslinked at 160° C., 200° C. or 240° C. for 45 minutes (see Table 6).

The carbon black paste used in the polyurethane paints of the compositions (A) to (F) was produced by homogenizing 177 g of butyl carbitol acetate, 37 g of dispersant Schwego Wett 6246 (polymers in combination with phosphoric esters) and 164 g of Surpass® black 7 (Sun Chemical Corporation, 55% by weight of carbon black in 45% by weight of Laropal® A 81) by means of a high-speed mixer at a circumferential velocity of 13.1-15.7 m/s for 20 minutes. The circumferential velocity should be at least 12 m/s for the carbon black to be dispersed sufficiently finely.

TABLE 4
a: Composition of the printing inks

| | Composition in % by weight | | | | | | | | |
|---|---|---|---|---|---|---|---|---|---|
| Paint component | A | B | C | D | E | F | G | H | I |
| Desmodur BL 3175 SN | 37.79 | 23.09 | 34.32 | — | 42.56 | 46.21 | 32.52 | 38.94 | — |
| (75% strength in solvent naphtha 100) | | | | | | | | | |
| Desmodur BL 3272 MPA | — | — | — | 40.11 | — | — | — | — | 42.21 |
| (72% strength in methoxypropyl acetate) | | | | | | | | | |
| Desmophen 651 | 35.75 | — | — | 33.43 | 30.98 | 27.33 | 30.78 | 36.84 | 27.07 |
| (65% strength in methoxypropyl acetate) | | | | | | | | | |
| Desmophen 670 | — | — | 44.83 | — | — | — | — | — | — |
| (60% strength in butyl carbitol acetate) | | | | | | | | | |
| Desmophen 680 | — | 50.45 | — | — | — | — | — | — | — |
| (70% strength in butyl acetate) | | | | | | | | | |
| Carbon black paste (contains 3.92 g of butyl carbitol | 8.38 | 8.38 | 8.38 | 8.38 | 8.38 | 8.38 | — | — | — |
| acetate) | | | | | | | | | |
| Pearl effect pigment Iriodin ® 111 Rutil Feinsatin | — | — | — | — | — | — | 10.30 | — | — |
| (TiO₂/SnO₂-coated mica, Merck KGaA) | | | | | | | | | |
| Pearl effect pigment Iriodin ® 305 Solar Gold | — | — | — | — | — | — | 0.90 | — | — |
| (Ti/Fe/Si/Sn oxide-coated mica, Merck KGaA) | | | | | | | | | |
| Graphit Timrex ® SFG15 (D90 = 15-20 μm) | — | — | — | — | — | — | 3.50 | — | — |
| Chromium complex dye ORASOL ® Black RLI | — | — | — | — | — | — | — | 2.22 | 2.22 |
| (BASF SE) | | | | | | | | | |
| Butyl carbitol acetate | 16.08 | 16.08 | 10.47 | 16.08 | 16.08 | 16.08 | 20.00 | 20.00 | 20.00 |
| Thickener Byk-410 (modified urea) | 1.50 | 1.50 | 1.50 | 1.50 | 1.50 | 1.50 | 1.50 | 1.50 | — |
| Thickener pyrogenic silica HDK-N20 (Wacker) | — | — | — | — | — | — | — | — | 8.00 |
| Antifoam Byk-054 (Polymer soln., silicone-free) | 0.50 | 0.50 | 0.50 | 0.50 | 0.50 | 0.50 | 0.50 | 0.50 | 0.50 |

b: Composition of the cured layers

| | Composition in % by weight | | | | | | | | |
|---|---|---|---|---|---|---|---|---|---|
| Layer component | A | B | C | D | E | F | G | H | I |
| Polyurethane | 93.4 | 93.6 | 93.5 | 93.3 | 93.5 | 93.5 | 75.2 | 96.0 | 82.5 |
| Laropal ® A 81 | 3.0 | 2.8 | 2.9 | 3.0 | 2.9 | 2.9 | — | — | — |
| Carbon black | 3.6 | 3.6 | 3.6 | 3.7 | 3.6 | 3.6 | — | — | — |
| Iriodin ® 111 | — | — | — | — | — | — | 17.4 | — | — |
| Iriodin ® 305 | — | — | — | — | — | — | 1.5 | — | — |
| Timrex ® SFG15 | — | — | — | — | — | — | 5.9 | — | — |
| ORASOL ® Black RLI | — | — | — | — | — | — | — | 4.0 | 3.8 |
| HDK-N20 | — | — | — | — | — | — | — | — | 13.7 |

TABLE 5
Colour stability of the display layers

| | | Thermal stress | | | | | | | | |
|---|---|---|---|---|---|---|---|---|---|---|
| | | A | | | D | | | H | | |
| | | | 12 h | 45 min | | 12 h | 45 min | | 12h | 45 min |
| Property | | none | 150° C. | 200° C. | none | 150° C. | 200° C. | none | 150° C. | 200° C. |
| Colour values | L* | 26.54 | 26.73 | 26.47 | 26.51 | 26.88 | 26.24 | 24.72 | 24.87 | 25.03 |
| (White tile) | a* | 0.03 | 0.07 | −0.05 | 0.09 | 0.09 | 0.11 | 1.39 | 1.40 | 1.47 |
| | b* | −0.28 | −0.13 | 0.09 | −0.60 | −0.46 | −0.58 | −1.60 | −1.67 | −1.87 |
| Colour difference | ΔE | — | 0.2 | 0.4 | — | 0.4 | 0.3 | — | 0.2 | 0.4 |

In a further embodiment, the order in which the display layer (5) and the top coat (4) are applied can be reversed: the display layer (5) is then applied after baking of the colour-imparting layer (2) in the display region (3) and the top coat (4) is, with a cut-out in the display region, applied to the dried display layer (5), as shown in FIG. 2. In this variant, it is important that the top coat (4) does not require a drying or baking temperature greater than 250° C. since the display layer based on polyurethane decomposes appreciably (with smoke formation) at temperatures above 250° C.

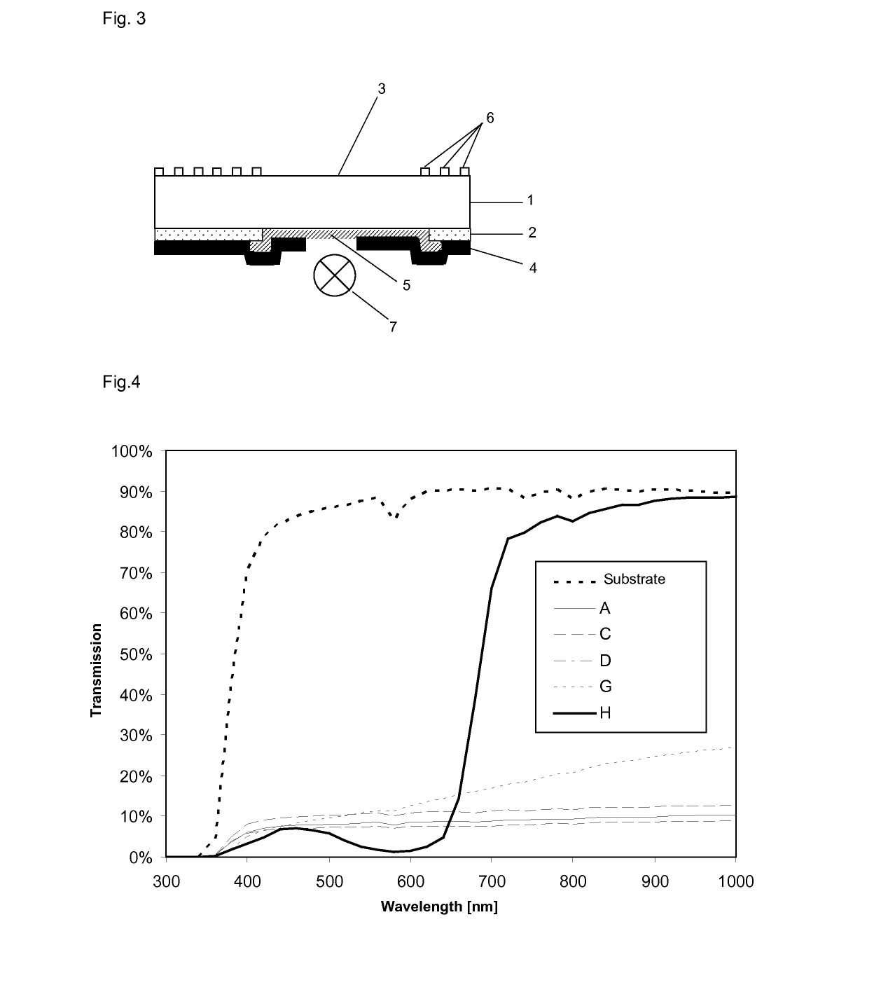

A further development of this embodiment is shown in FIG. 3, in which the top coat (4) extends into the display region (3) and only isolated, small regions remain free, e.g. directly over the lighting means (7). The advantage of this embodiment is that even when the cooking area is extremely strongly illuminated (e.g. by means of halogen lamps of modern vapour extraction hoods) in the display region (3), it is not possible to see into the hob because the top coat (4) reduces the transmission, with the exception of particular regions (e.g. directly over LEDs), to below 2%.

As a result of the display layer being applied in a separate (second or third) printing step in the cut-out region provided, the colour shade of the display layer can be selected independently of the surrounding, colour-imparting layer.

The layer thickness of the colour-imparting sol-gel layer and the sol-gel top coat is a total of 35.4±3.0 μm in this example. The layer thickness of the display layer having composition (A) is 10.3±0.1 μm. The layer thicknesses of the other compositions (B) to (I) are in the same order of magnitude because all illustrative compositions were printed by means of a mesh screen 54-64 and the solids content of the compositions (A) to (I) is comparable (54-60% by weight). The display layers could be printed without problems, i.e. without unprinted regions at the edges, into the cut-out region.

The transmission in the region of visible light, τᵥᵢₛ, is 8.2% for the display layer based on the composition (A). The transmission of the other, carbon black-pigmented layers is of the same order of magnitude (7.3-10.6%), since the predetermined carbon black content of the carbon black-pigmented variants (A)-(F) is constant at 3.6% and the paints were printed using the same screen mesh (54-64). The transmission differences between the display layers obtained are due to fluctuations in the production of the paint and the printing of the coating. Overall, a high reproducibility in the manufacturing process can be concluded from the relatively low transmission differences.

FIG. 4 shows the transmission curve of the uncoated glass-ceramic and the glass-ceramic coated with composition (A) in the display region. The transmission T is was calculated from the transmission curve in accordance with DIN EN 410 for standard light type D65, 2° observer. It is conspicuous that the transmission of the glass-ceramic provided with the coating (A) is virtually constant over the entire wavelength range of visible light (400-750 nm). The change is only 3.1%. A comparable situation applies to the other carbon black-pigmented compositions (B) to (F). The carbon black-pigmented polyurethane layers therefore differ from all other display coatings known hitherto in terms of their virtually unchanged transparency over the entire wavelength range.

For example, the transmission of the noble metal coating disclosed in DE 10 2006 027 739 B4 for violet light (400 nm) is 2.8% and that for dark red light (750 nm) is 13.5%. The transmission difference between the two types of light is thus 10.7% and is therefore more than three times as great as the transmission differences for carbon black-pigmented polyurethane layers. Other noble metal coatings available on the market have even larger transmission differences. Display layers having a sol-gel basis (e.g. as described in DE 10 2009 010 952) also have relatively large transmission differences between violet and dark red light of 11% and even up to 20%.

The carbon black-pigmented polyurethane display layers are therefore many times better for multicolour displays than the display coatings available on the market because the carbon black-pigmented polyurethane layers are uniformly transparent over the entire visible spectrum to an extent which has not been achieved hitherto and therefore allow, for example, blue, green, yellow, white, red LEDs or other lighting means to shine through with equal brightness. This effect is desirable because the market is at present demanding cooking surfaces having display regions which are equally sufficiently transparent for red light and also for blue light.

The scattering of the display layer having the composition (A), determined by the same method as in DE 10 2006 027 739 B4, is 3.7-5.1% in the region of visible light. The scattering of the carbon black-pigmented layer is thus greater than in the case of the noble metal layers as described in DE 10 2006 027 739 B4 but significantly less than in the case of the silicone and sol-gel display layers available on the market (see DE 10 2009 010 952 and comparative examples in DE 10 2006 027 739 B4).

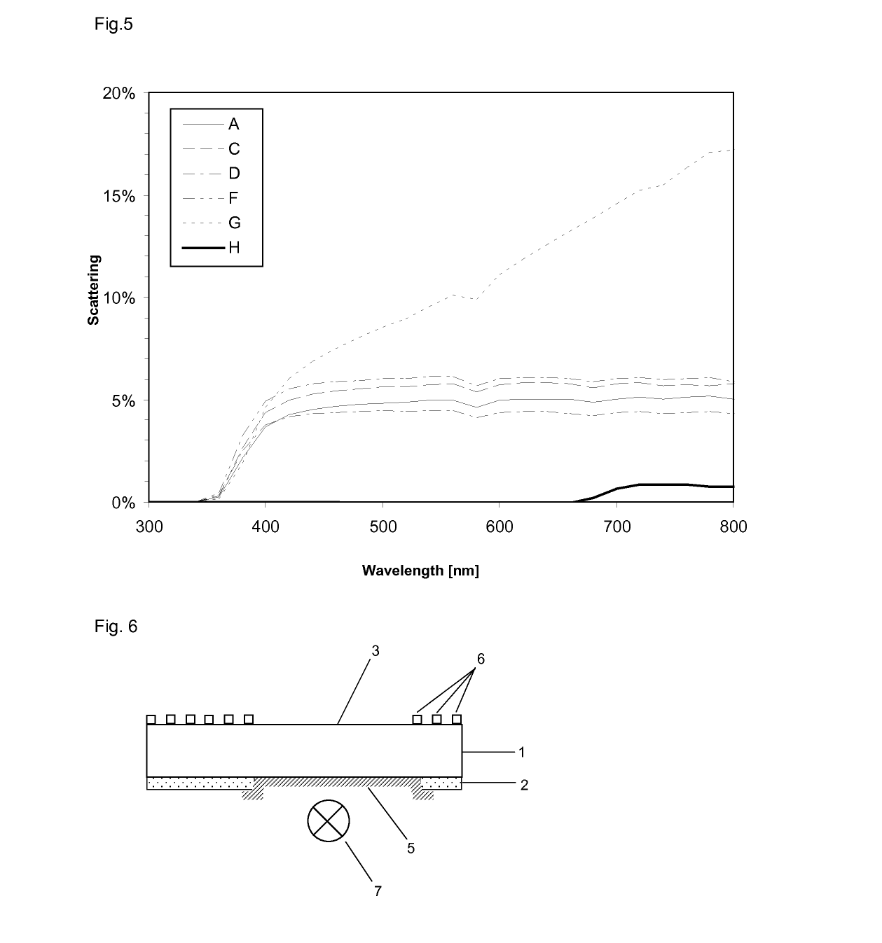

FIG. 5 shows the scattering curve of the glass ceramic coated with the display layers of the compositions (A), (C), (D), (F) to (H) in the relevant wavelength range 400-750 nm. In the interests of clarity, the scattering curves of the compositions (B), (E) and (I) have not been shown; the scattering curves of the compositions (B) and (E) run between the curves (D) and (F), and the scattering curve of the composition (I) virtually coincides with curve (H). The scattering of visible light by the uncoated glass-ceramic is negligibly small, because, inter alia, the roughness of the uncoated, transparent glass-ceramic is only R₃=0.004±0.001 μm. The roughness of the carbon black-pigmented polyurethane layers (A) to (F) is in the range 0.01-0.02 μm. The low roughness of the glass-ceramic and the layers (A) to (F) and also (H) and (I) is the prerequisite for the low scattering and the associated high display quality which extends to that of the noble metal layers. FIG. 5 also shows the scattering of the polyurethane layer having the composition (G), which contains relatively coarse pigments. With Rₐ=0.43±0.08 μm, the coating (G) is significantly rougher and scatters light strongly. The display quality is correspondingly moderate. The pigmenting of the coating (G) corresponds to the pigmenting of example (B) in DE 10 2009 010 952 (ratio of Iriodin content to graphite content=3.2:1). Both layers therefore have a comparable colour shade, a comparable transmission and scattering. However, in contrast to example (B) in DE 10 2009 010 952, in which a scratch resistance of 200 g is achieved, the polyurethane coating (G) is substantially more scratch-resistant (the scratch resistance is 800 g).

The scattering in variants (H) and (I) is extremely low because a soluble, organic dye was used for colouring. Since no solid particles are present in the composition (H) and the surface coating levels out uniformly, the roughness of the cured coating (H) is in the same order of magnitude as the roughness of the uncoated glass-ceramic surface. The display quality of the coatings (H) and (I) is excellent (very clear display of blue, green, white or red LEDs) and is not inferior to the quality of noble metal layers.

The roughness was determined in accordance with DIN EN ISO 4288 by means by a tracing step profilometer. The standard deviation was calculated from three representative measurements. (Single measurement distance λc=0.08 mm, measurement distance λn=0.40 mm, total 0.48 mm scan length [measurement distance including prerun and after-run of ½λc in each case]; in the case of example (G), λc=0.80 mm, λn=4.0 mm and the total scan length was 4.8 mm).

The finished, coated cooking surface was installed in a hob and tested under conditions relevant to practice (with illumination under conventional vapour extraction hoods) to determine whether the switched-on illuminated display (7 segment display of a touch control operating panel from E.G.O.) is sufficiently discernible. Since the lighting elements of the display which are customary at present can clearly be seen from a distance of 60-80 cm (i.e. shine through the coated glass-ceramic with sufficient sharpness and brightness), the transmission of the display layers (A) to (I) is satisfactory. With the illuminated display switched off, a test was carried out under the same lighting conditions to determine whether the display layers can be discerned through the touch control operating panel. Since the operating panel was not discernible in the switched-off state, the display layers restrict the view into the hob to a sufficient extent.

Since the display layers do not contain any noble metals, they are significantly cheaper than coatings based on noble metal preparations.

The scratch resistance of the coatings (A) to (1) is at least 300 g and extends to above 1000 g. The scratch resistance of the polyurethane coatings is therefore a number of times that of conventional display layers having silicone resins as film formers, which do not even withstand a loading of 100 g. The scratch resistance of polyurethane coatings is from about twice to three times that of display layers having a sol-gel basis (DE 10 2009 010 952) and is of the same order of magnitude as the scratch resistance of noble metal coatings (DE 10 2006 027 739 B4).

The measurement of the scratch resistance was carried out by placing the cemented carbide type (tip radius: 0.5 mm) loaded with the respective weight (100 g, 200 g, . . . , 800 g, 900 g, 1000 g) vertically on the coating and moving it over the coating for a distance of about 30 cm at a velocity of 20-30 cm/s. Evaluation was carried out by means of the view of the user through the glass-ceramic. The test is counted as passed at the selected loading when no damage is discernible from a distance of 60-80 cm with a white background and daylight D65.

The scratch resistance of the polyurethane layers is dependent on the crosslinking temperature and the crosslinking time. In the case of the polyurethane systems presented, dry, firm-to-the-touch layers having a scratch resistance in the range from 100 to 200 g are obtained at 140° C. and above (45 minutes). Only above 160° C. (45 minutes) are significantly higher scratch resistances of 300 g and above obtained. In the case of systems (A) and (C), a temperature increase did not lead to any further increase in the scratch resistance, while the scratch resistance of the system (B) and of the ε-caprolactam-blocked system (D) could be increased to 600 g by increasing the temperature to 200° C. (45 minutes). Increasing the crosslinking temperature further to up to 240° C. gave no further increase in the scratch resistance. However, extremely high scratch resistances of from 800 g to >1000 g could be achieved using the variants (E) and (F) by crosslinking at 240° C. The cause of the high scratch resistance of these variants is the high crosslinking density which can be achieved because of the excess of hardener. The high scratch resistance of variant (G) is also conspicuous, and is presumably due to the mica platelets present. Variant (H), which is based on a comparable binder composition to variant (A), has, as expected, a scratch resistance comparable to that of variant (A).

The adhesion of the cured polyurethane layers (A) to (I) is satisfactory. It was tested by means of the “TESA test”, in which a strip of transparent adhesive tape is rubbed onto the cured coating and then torn off with a jerk (Tesa film type 104, Beiersdorf AG). Since the coatings could not be detached from the glass-ceramic by means of the adhesive tapes, they adhere sufficiently strongly.

However, it has been found that the adhesion of some systems is drastically reduced by treatment with water (24 hours). The coatings (A) to (D) are detached from the glass-ceramic substrate by the “TESA test” after treatment with water. However, since the display layers are in practice not exposed to such a higher level of moisture, the adhesion is estimated as satisfactory. In the case of high humidity, the electronics in the hob, for example, would be damaged and iron-containing components (frames, etc.) would corrode and capacitive touch switches underneath the display region would no longer function because of the electrical conductivity of water. The treatment with water can be used to detach defective, cured display layers from the substrate again in order to carry out coating of the display region once more.

The resistance to water can be improved by carrying out crosslinking at a higher temperature. Thus, for example, variant (C) passes the “TESA test” after treatment with water for 24 hours when the coating is crosslinked at 200° C. (45 minutes). Variant (A) passes the “TESA test” after treatment with water when the coating is crosslinked at 240° C. (45 minutes). On the other hand, the compositions (G) and (H) display sufficient adhesion after treatment with water at the usual crosslinking temperature (160° C.). This result indicates that the adhesion of the variants (A) to (F) is reduced by the Laropal® A 81 present and that coatings having improved adhesion can be obtained by the absence of Laropal® A 81 (or other resins which are not resistant to moisture).

The impact strength of the glass-ceramic is surprisingly not reduced by the polyurethane layers which adhere well. The layers are, despite their hardness, obviously sufficiently elastic to equalize stress differences due to different thermal expansion. The impact strength was determined by the falling ball test using a steel ball (200 g, 36 mm diameter).

Although the display layers (A) to (F) contain an electrically conductive pigment (3.6% by weight of carbon black based on the cured layer), the coatings are suitable for capacitive touch switches. Testing was carried out by means of a touch control control panel from E.G.O. The cooking zones could be switched without problems via the capacitive touch switches of the unit when the display layers having the compositions (A) to (F) were arranged above the touch switches (8) (FIG. 1). This is because the electrical surface resistance of the coatings at room temperature (20° C.) is above 350 GΩ/square (30 GΩ/square at 100° C., 1 GΩ/square at 150° C.). A surface resistance in the megaohm range is considered to be sufficient for problem-free functioning of capacitive touch switches. The display layers (G), (H) and (I) are also suitable for capacitive touch switches.

The surface resistance of a display coating can be determined relatively simply by means of an ohmmeter, by placing the two electrodes of the measuring instrument very close to one another (at a spacing of about 0.5-1 mm) on the coating. The resistance indicated by the measuring instrument corresponds approximately to the surface resistance of the coating.

The display layers of the compositions (A) to (F) which are pigmented with carbon black and also variant (G) are unsuitable for infrared touch switches because the transmission in the near infrared region (at 940 nm) is 25% or below (cf. FIG. 4 and DE 10 2009 010 952). However, owing to the high transmission for light of the wavelength 940 nm (88%), the compositions (H) and (I) are highly suitable for infrared touch switches. From this point of view, the variants (H) and (I) are superior to the noble metal layers presented in DE 10 2006 027 739 B4, which are suitable exclusively for capacitive touch switches but not for IR touch switches.

The stability of the colour shade of the display layers (A), (D) and (H), as representatives of all other formulations, was tested by comparison of the colour values obtained before and after thermal stressing (12 hours at 150° C. or 45 minutes at 200° C.).

The colour values of the coatings having the compositions (A), (D) and (H) before and after thermal stressing are shown in Table 5. They were measured using a spectrophotometer (Mercury 2000, from Datacolor; light type D65; observation angle: 10°) from the point of view of the user, i.e. measured through the substrate, with the white tile which was also used for calibrating the measuring instrument being placed under the display layer. This measure is necessary because the transparent display layers have to be measured against a reproducibly identical background for colour position comparison. The colour values are reported according to the CIELAB system (DIN 5033, part 3 “Colour measurement indices”). In accordance with DIN 6174, the colour difference ΔE was not more than 0.2-0.4. The colour difference determined is very small; it is in the range of measurement accuracy (0.1-0.2) or just above. Examination by an eye having normal vision found no colour difference after 12 hours at 150° C. and a small, barely perceptible colour difference after 45 minutes at 200° C. The polyurethane systems are therefore sufficiently stable to the expected thermal stress.

The properties of the display coatings discussed are summarized in Table 6.

TABLE 6
Properties of display layers on glass-ceramic

| | Composition | | | | | | | | |
|---|---|---|---|---|---|---|---|---|---|
| Property | A | B | C | D | E | F | G | H | I |
| Layer thickness | 10.3 ± | 9.9 ± | 10.3 ± | 10.7 ± | 10.6 ± | 9.6 ± | 10.5 ± | 10.1 ± | 10.6 ± |
| in [μm] | 0.1 | 0.1 | 0.1 | 0.7 | 0.2 | 0.2 | 0.1 | 0.1 | 0.3 |
| (54-64) | | | | | | | | | |
| Transmission | 8.2% | 8.3% | 10.6% | 7.3% | 7.6% | 9.7% | 11.2% | 3.0% | 3.2% |
| Tᵥᵢₛ | | | | | | | | | |
| Transmission | 5.9% | 6.4% | 8.0% | 5.9% | 5.9% | 7.6% | 5.1% | 3.2% | 3.5% |
| at 400 nm | | | | | | | | | |
| Transmission | 9.0% | 8.9% | 11.4% | 7.9% | 8.3% | 10.3% | 18.7% | 80.6% | 81.2% |
| at 750 nm | | | | | | | | | |
| Transmission | 3.1% | 2.5% | 3.4% | 2.0% | 2.4% | 2.7% | 13.6% | 77.4% | 77.7% |
| difference | | | | | | | | | |
| ΔT_{400 nm-750 nm} | | | | | | | | | |
| Transmission | 10.0% | 9.9% | 12.6% | 8.8% | 9.3% | 11.4% | 25.8% | 88.3% | 87.7% |
| at 940 nm | | | | | | | | | |
| Suitability | no | no | no | no | no | no | no | yes | yes |
| for IR touch | | | | | | | | | |
| sensors | | | | | | | | | |
| Suitability | yes | yes | yes | yes | yes | yes | yes | yes | yes |
| for capacitive | | | | | | | | | |
| sensors | | | | | | | | | |
| Scratch | 400 g | 600 g | 300 g | 600 g | 800 g | >1000 g | 800 g | 500 g | 400 g |
| resistance | (160° C.) | (200° C.) | (160° C.) | (200° C.) | (240° C.) | (240° C.) | (160° C.) | (160° C.) | (200° C.) |
| (Crosslinking | | | | | | | | | |
| temperature) | | | | | | | | | |
| Adhesion | o.k. | o.k. | o.k. | o.k. | o.k. | o.k. | o.k. | o.k. | o.k. |
| Roughness | 0.012 ± | 0.011 ± | 0.017 ± | 0.017 ± | 0.010 ± | 0.012 ± | 0.428 ± | 0.002 ± | 0.016 ± |
| of the layer | 0.001 | 0.001 | 0.001 | 0.001 | 0.001 | 0.001 | 0.078 | 0.001 | 0.002 |
| [μm] | | | | | | | | | |
| View into | yes | yes | yes | yes | yes | yes | yes | yes | yes |
| hob sufficiently | | | | | | | | | |
| reduced | | | | | | | | | |
| Sufficiently | yes | yes | yes | yes | yes | yes | yes | yes | yes |
| permeable for | | | | | | | | | |
| illuminated | | | | | | | | | |
| displays | | | | | | | | | |
| Viscosity | 1330 | 810 | 500 | 1050 | 1040 | 940 | 1210 | 1210 | 2900 |
| at 200 s⁻¹ | | | | | | | | | |
| (mPa s) | | | | | | | | | |
| Scattering | 3.7% | 4.1% | 4.4% | 3.8% | 4.0% | 4.9% | 4.6% | 0.01% | 0.05% |
| at 400 nm | | | | | | | | | |
| Scattering | 5.1% | 4.6% | 5.7% | 4.3% | 4.8% | 6.0% | 15.8% | 0.79% | 0.83% |
| at 750 nm | | | | | | | | | |

In a further embodiment, the polyurethane layers can also be used as display layers for cooking surfaces which are provided on the underside with colour-imparting noble metal layers. Cooking surfaces having noble metal layers as underside coating are known from, for example, DE 10 2005 046 570 B4 and DE 10 2008 020 895 B4. The opaque noble metal layers are cut out in the display region. The coating of the display region with the polyurethane systems presented gives a display layer which, as described above, has sufficient transmission for the light of the lighting elements and at the same time effectively prevents a view into the interior of the cooking hob.

The polyurethane coating (5) can, as shown in FIG. 6, be applied so as to overlap the baked noble metal layer (2) and be thermally cured. When a polyurethane system which has been pigmented with carbon black or coloured by means of organic colorants is used, such a polyurethane coating can replace, for example, the noble metal display layer mentioned in DE 10 2006 027 739 B2 without deterioration of the display quality (scattering, transmission in the visible spectral region) having to be accepted.

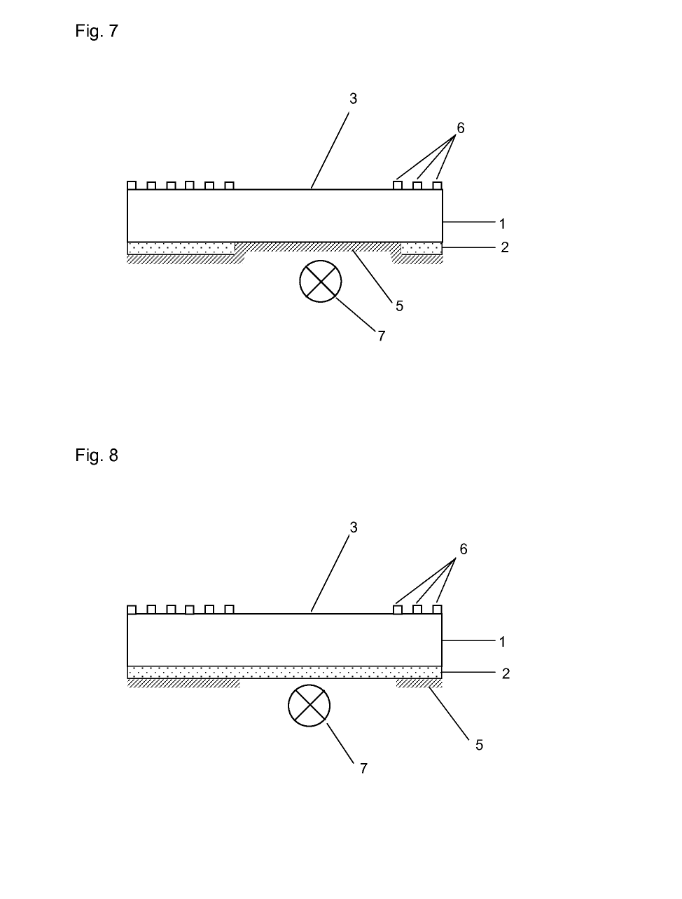

However, the polyurethane coating (5) can also be applied not only to the display region but also over the entire noble metal layer (FIG. 7). However, regions which during operation of the cooking surface become hotter than 250° C. should then be cut out to avoid the formation of decomposition products during operation. The polyurethane layer then has not only the function of display layer but also the function of a protective layer because it can protect the noble metal layer (2) against scratching or against penetration of fats or silicones (e.g. from adhesives). This embodiment in which the polyurethane layer is applied not only in the display region but also over virtually the entire cooking surface has the advantage that no further protective layer has to be applied.

Not only noble metal layers but also sol-gel layers, sputtered layers or glass-based layers can be protected against scratching or against penetration of fats or silicones by the polyurethane layer. In particular cases, the colour of the polyurethane layer is matched to the colour of the colour-imparting layer, so that the polyurethane layer can cover flaws in the colour-imparting layer.

In further embodiments analogous to FIG. 1, FIG. 2 and FIG. 3, another paint (4), e.g. a silicone-modified alkyd resin system can be used to protect the noble metal layer (2); this other paint may have a colour matched to the noble metal system so as to cover flaws such as holes in the noble metal layer. As mentioned above, in the variants shown in FIG. 2 or FIG. 3, the top coat (4) has to be able to be cured at temperatures up to 250° C. since decomposition of the polyurethane system commences at higher temperatures. A grey protective layer (4) can, for example, cover holes in a silver-coloured noble metal coating, and a black protective layer can cover holes in a black noble metal layer. It has been found that the polyurethane system is sufficiently compatible with alkyd resin systems for no adhesion problems to occur at the places where the layers overlap.

In the case of control panels, decorative panels, optical lenses, baking oven windows, chimney sight glasses or other components which do not become hotter than 200° C., including, for example, cooking surfaces having fine temperature control, there are further possible combinations for the polyurethane system presented.

The first paint layer on the substrate can then also consist of polyurethane. Display regions and opaque regions (transmission below 1%) can in this way be produced by back-printing with one or more layers of polyurethane paint. Possibilities are both the embodiment as shown in FIG. 7 and the inverse embodiment as shown in FIG. 8, where the first paint layer (2) or the second paint layer (5) or both paint layers are cut out in at least one region and are located on the same side of the substrate.

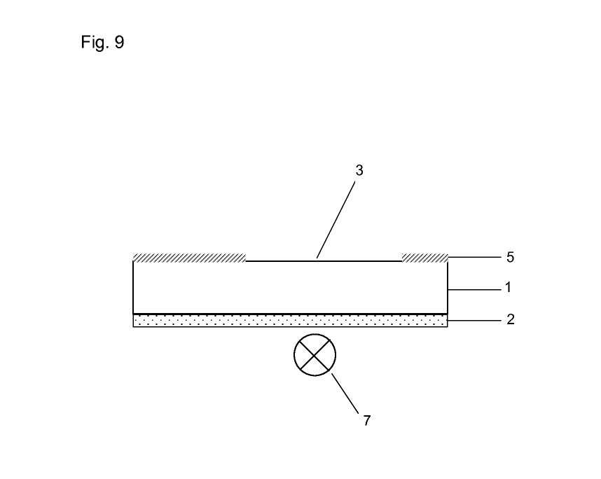

In the case of control or decor panels or other components in which the side facing the user is not subject to excessive mechanical stress, the polyurethane layers (2) and (5) can also be applied on opposite sides. As shown in FIG. 9, display regions and opaque regions can likewise be produced in this way. Depending on the desired transparency, a plurality of identically coloured or differently coloured paint layers can also be arranged on top of one another on one side. The polyurethane layers can also be combined with other coatings (enamels, epoxy resin layers, polyamide layers, etc.) by overprinting and cutting out.

### LIST OF REFERENCE NUMERALS

1 Substrate
2 Colour-imparting layer
3 Display region
4 Top coat
5 Display layer
6 Upper side decor
7 Lighting means
8 Touch switch

1-20. (canceled)

21. A smooth, transparent shaped polymer, glass or glass-ceramic body having a transparent coating comprising a colored polyurethane system, wherein the colored polyurethane system comprises a polyisocyanate that has been thermally crosslinked by an H-acid compound, and wherein the body having the transparent coating has a transmission for visible light in the range 1-20%.

22. The body according to claim 21, wherein the transparent coating has a starting material that consists of a blocked polyisocyanate and an H-acid compound.

23. The body according to claim 22, wherein the blocked polyisocyanate is selected from the group consisting of an aliphatic, aromatic, cycloaliphatic, and araliphatic polyisocyanate.

24. The body according to claim 22, wherein the blocked polyisocyanate an aliphatic polyisocyanate based on hexamethylene diisocyanate.

25. The body according to claim 22, wherein the blocked polyisocyanate has an average molecular weight of from 800 to 10 000 g/mol.

26. The body according to claim 22, wherein the blocked polyisocyanate has an average molecular weight of from 1000 to 1100 g/mol.

27. The body according to claim 22, wherein the blocked polyisocyanate has from 2 to 50 blocked isocyanate groups per molecule.

28. The body according to claim 22, wherein the blocked polyisocyanate has from 2 to 6 blocked isocyanate groups per molecule.

29. The body according to claim 21, wherein the H-acid compound is selected from the group consisting of a polyol, a polyester polyol, a polyether polyol, an amine, a polyamine, a transesterification product of castor oil, linseed oil, soya bean oil, an alkyd, epoxy, silicone, phenol resin, polyacrylate resin, a vinyl polymer, a cellulose ester, where the H-acid compound has an average molecular weight of from 1000 to 2000 g/mol and a hydroxyl group content of from 2 to 8% by weight.

30. The body according to claim 21, wherein the starting material comprises a ratio of blocked polyisocyanate and the H-acid compound of from 1:1 to 2:1.

31. The body according to claim 30, wherein the ratio is from 1.1:1 to 1.6:1.

32. The body according to claim 21, wherein the transparent coating has a polyurethane content in the range from 55 to 99.9% by weight.

33. The body according to claim 21, wherein the transparent coating has a polyurethane content in the range from 75 to 96% by weight.

34. The body according to claim 21, wherein the colored polyurethane system further comprises pigments selected from the group consisting of organic colored pigments, inorganic colored pigments, white pigments, black pigments, and combinations thereof, where the pigments have a particle diameter of less than 25 μm.

35. The body according to claim 21, wherein the colored polyurethane system further comprises pigments selected from the group consisting of liquid-crystalline pigments, organic lustre pigments, inorganic lustre pigments, luminous pigments, and combinations thereof.

36. The body according to claim 22, wherein the colored polyurethane system further comprises at least one organic or inorganic dye, where the at least one organic or inorganic dye is soluble in the starting material.

37. The body according to claim 36, wherein the at least one organic or inorganic dye is an organic dye selected from the group consisting of acridine, copper phthalocyanine, phenothiazine blue, disazo brown, quinoline yellow, a cobalt, chromium or copper complex dye of the azo, azomethine or phthalocyanine series, an azo chromium complex black, phenazine flexo black, thioxanthene yellow, benzanthrone red, perylene green, and a chromium metal complex dye.

38. The body according to claim 21, wherein the colored polyurethane system further comprises a dye content in the range from 0.1 to 45% by weight.

39. The body according to claim 21, wherein the transparent coating has a layer thickness in the range from 0.1 to 1000 μm.

40. The body according to claim 21, wherein the transparent coating has a layer thickness in the range from 5 to 20 μm.

41. The body according to claim 21, wherein the transparent coating has a roughness that is less than 0.5 μm.

42. The body according to claim 21, wherein the transparent coating has a roughness that is from 0.001 μm to 0.02 μm.

43. The body according to claim 22, wherein the starting material further comprises a material selected from the group consisting of solvent, thickeners, thixotropes, antifoams, wetting agents, levelling agents, catalysts, an aprotic solvent of medium volatility, an aprotic solvent of low volatility, a polyacrylate thickener that is solid or viscous at 20° C., a polysiloxane, a thixotropic acrylic resin, an alkyd resin which has been made thixotropic by isocyanate or urethane, a wax, an associative acrylate thickener, a hydrophobically modified cellulose ether, ether urethane, polyether or a modified urea or an amorphous silica, a hydrophilic silica, a pyrogenic silica, an organic sheet silicate, a metal soap, a tertiary amine catalyst, a metal-containing salt catalyst, antimony salt catalyst, and any combinations thereof.

44. The body according to claim 21, wherein the transparent coating further comprises a thickener in a range from 0.1 to 25% by weight, preferably from 10 to 15% by weight.

45. The body according to claim 21, wherein the transparent coating further comprises a thickener in a range from 10 to 15% by weight.

46. The body according to claim 21, wherein the transparent coating has a surface resistance of >10⁶ Ω/cm² in the temperature range from 20° C. to 150° C.

47. The body according to claim 21, wherein the body having the transparent coating has a transmission of greater than 25% at a wavelength of 940 nm and has a maximum transmission change of 3.4% in a visible wavelength range of 400 to 750 nm.

48. The body according to claim 21, further comprising a coating that at least partly covers the transparent coating, wherein the coating comprises the group consisting of a noble metal, a sol-gel, an alkyd resin, a silicone, an epoxy resin, polyamide coating, a glass-based coating, and polyurethane coating.

49. The body according to claim 21, wherein the body having the transparent coating is suitable for a use selected from the group consisting of a plate, a cooking surface, a control panel, an optical lens, a chimney sight glass, a baking oven window, a display region, a fitting window, an automobile window.

50. The body according to claim 21, wherein the body has the transparent coating on a region selected from the group consisting of one side, both sides, and only part of one side.
